(19) United States
(12) Patent Application Publication
(10) Pub. No.: US 2003/0212837 A1
(43) Pub. Date: Nov. 13, 2003

(54) Rate converter and rate conversion method

(75) Inventor: Toshiki Tada, Neyagawa-shi (JP)

Correspondence Address: PARKHURST & WENDEL, L.L.P., 1421 PRINCE STREET, SUITE 210, ALEXANDRIA, VA, 22314-2805, US

(73) Assignee: MATSUSHITA ELEC IND CO LTD, Kadoma-shi (JP)

(21) Appl. No.: 10/420,935

(22) Filed: Apr. 23, 2003

(30) Foreign Application Priority Data
Apr. 25, 2002 (JP) 2002-124203

(51) Int. Cl. G06F 3/00

(52) U.S. Cl. 710/1

(57) ABSTRACT

The present invention provides a rate converter that converts plural input rates into integer-multiplied rates, respectively, in which the number of delay elements that are necessary for the rate converter is reduced. This rate converter includes an input delay unit 11 that delays inputted data successively by means of plural delay elements; a selection unit 12 that selects data that have been delayed by the delay elements in the input delay unit 11 from taps of the delay elements according to the respective rates of the inputted data, so that the times from when the data at the respective rates are inputted to the rate converter 10 to when the data are outputted therefrom are kept constant; an interpolation unit 13 that performs interpolation processing for the data selected by the selection unit 12 so as to integer-multiply the rate of the selected data; and an output delay unit 14 that adjusts output timing of the data after interpolation processing, by means of a single delay element or plural delay elements.

### FIELD OF THE INVENTION

The present invention relates to a rate converter and a rate conversion method for performing rate conversion to data that are inputted at plural kinds of rates.

### BACKGROUND OF THE INVENTION

Conventionally, video data such as luminance data or color-difference data are subjected to processing of converting the rate of the digital data (see Japanese Published Patent Application No. Hei.01-109813). There are rate converters that can perform the rate conversion for data which are inputted at plural kinds of input rates. For example, one rate converter can perform the rate conversion for 13.5 MHz luminance data and 27 MHz luminance data. The rate converters which can handle plural input rates require that the times from when respective data at the plural input rates are inputted to the rate converter to when the data are outputted therefrom (i.e., the times required for the rate conversion, hereinafter this time is referred to as “input-to-output time”) are kept constant. When the input-to-output times (the times necessary for the rate conversion) vary with the input rates, timings in which the data are outputted from the rate converter unfavorably vary with the rates, thereby causing problems such as displacement of images.

Hereinafter, a conventional rate converter that handles plural input rates and keeps the input-to-output times corresponding to the respective input rates constant will be described with reference to FIGS. 6 to 9.

FIG. 6 is a block diagram illustrating a construction of a conventional rate converter, and FIG. 7 is a diagram illustrating a detailed construction of the conventional rate converter.

In FIG. 6, the conventional rate converter includes an input delay unit 21 that performs delay processing for holding (a−1) pieces of data among “a” pieces of data (“a” is a natural number) which are necessary for interpolation processing; an interpolation unit 22 that performs the interpolation processing with employing the data held by the input delay unit 21 to convert the input rate of the inputted data to be multiplied by an integral factor; and an output delay unit 23 that receives data that has been subjected to the interpolation processing by the interpolation unit 22 or data that has not been subjected to the interpolation processing but is inputted from the input delay unit 21 to be outputted through as it is (hereinafter, this data will be referred to as “through-output data”), and performs delay processing for the received data so that input-to-output times corresponding to data at the respective rates are kept constant.

Hereinafter, the conventional rate converter will be described in more detail with reference to FIG. 7. It is assumed here that the interpolation unit 22 requires seven pieces of input data to perform the interpolation processing, and converts the rate of the inputted data into a doubled rate.

The input delay unit 21 includes delay elements 201 to 206 for performing delay processing of holding (a−1) pieces of data among “a” pieces data (“a” is a natural number, a=7 in FIG. 7) which are necessary for the interpolation processing, and an input delay control unit 210 that outputs an enable signal to the delay elements 201 to 206. The interpolation unit 22 performs the interpolation processing of converting the rate of the inputted data to be multiplied by an integral factor, with employing data from taps of the delay elements 201 to 206. In this case, in the interpolation processing performed by the interpolation unit 22, new data are inserted between data to multiply the rate of the data by an integral factor. As exemplary ways to implement this processing, there is a method in which inputted data are outputted as they are and new data are inserted between adjacent two pieces of inputted data, or a method in which function approximation is performed for some pieces of inputted data, then a value obtained by the function approximation is outputted in place of the inputted data, and the value obtained by the approximation of function is outputted also as new data that is to be inserted between adjacent two pieces of inputted data. A simple example of the former is a method by which an average of adjacent two inputted data is outputted as new data to be inserted between the two data.

The output delay unit 23 includes delay elements 211 to 220 for performing delay processing to the data after interpolation processing, so that the input-to-output times corresponding to the respective inputted data are kept constant, an output delay control unit 230 that outputs an enable signal to the delay elements 211 to 220, selectors 234 to 236 that select data from taps of predetermined delay elements among the delay elements 201 to 206 and 211 to 220 so that the input-to-output times corresponding to the plural input rates are kept constant, and a selector 237 that changes data to be inputted to the delay element 211 between in the case where the rate conversion is performed and in the case where the rate conversion is not performed (the latter case is hereinafter referred to also as though-outputting).

The operation of the above-mentioned conventional rate converter will be described with reference to FIGS. 8 and 9. It is assumed here that the conventional rate converter handles two different input rates (f1 and f2=2×f1), the respective input rates f1 and f2 have the same input-to-output time, and the interpolation unit 22 requires seven pieces of inputted data to perform interpolation processing and converts the rate of the inputted data into a doubled rate.

Initially, the case where the input rate of data that is inputted to the conventional rate converter is f1 is described with reference to FIG. 8. FIG. 8 are timing charts for signals that are outputted from respective parts of the conventional rate converter in the case where the rate of the inputted data is f1.

When the input rate is f1, the input delay control unit 210 outputs initially an enable signal of the f1 rate (hereinafter, referred to as a “f1 enable signal”). Then, the delay elements 201 to 206 delay the data that has been inputted to the rate converter, in accordance with the f1 enable signal. For example, when data of “A”, “B”, “C”, “D”, “E”, “F”, “G” , . . . are successively inputted to the rate converter, data as shown in FIG. 8 are outputted from the delay elements 201 and 206.

The interpolation unit 22 reads the data inputted from outside and the inputted data that has been delayed by the respective delay elements 201 to 206 in accordance with the f1 enable signal. Since the interpolation unit 22 requires seven pieces of the inputted data in the interpolation processing as described above, when reading seven pieces of data “A” to “G” from respective taps of the delay elements 201 to 206 (at time “T1” in FIG. 8), the interpolation unit 22 first outputs data that is located in the middle of the seven data (fourth data from the beginning, i.e., data “D”). Then, the interpolation unit 22 interpolates data between the fourth data “D” and the fifth data “E”, and outputs data “D′” as interpolation data between the data “D” and “E”. As discussed above, the interpolation unit 22 successively reads seven pieces of data, and interpolates data between the fourth data and the fifth data among the data which have been inputted to the interpolation unit 22, to output data after the interpolation processing (“D”, “D′”, “E”, “E′” , . . . ) as shown in FIG. 8. Then, the data after the interpolation processing are inputted to the delay element 211 through the selector 237.

The data that have been subjected to the interpolation processing by the interpolation unit 22 in the above-mentioned manner are inputted to the delay element 211 as shown in FIG. 8, and delayed by the delay elements 211 and 212. This delay processing is performed in accordance with an enable signal of a 2×f1 rate that is outputted from the output delay control unit 230. Then, data outputted from the delay element 212 is selected by the selectors 235 and 236 as data to be outputted. The outputted data has a rate of f2 (=2×f1), and this means that the f1 rate of the input data is converted into a doubled rate. Here, the reason why not the output from the delay element 211 but the output from the delay element 212 is inputted to the selector 235 is because the input-to-output time in the case where the input data is outputted through as it is without being subjected to the rate conversion and the input-to-output time in the case where the input data is outputted after being subjected to the rate conversion should have the same value. More specifically, while the input-to-output time at the through-outputting is an integral multiple of 1/f1, when data that is subjected to rate conversion and outputted from the delay element 211 is inputted to the selector 235, the input-to-output time is not an integral multiple of 1/f1 (see FIG. 8), and accordingly the data is additionally delayed in the delay element 212 by 1/(2×f1) to adjust the output timing. Therefore, as can be seen from a time period from when the data “D” is inputted to the rate converter to when the data is outputted therefrom in FIG. 8, the input-to-output time in this case is 4×1/f1.

Next, the case where the input rate of the inputted data is f2 will be described with reference to FIG. 9. FIG. 9 are timing charts for signals that are outputted from respective parts of the conventional rate converter in the case where the rate of the inputted data is f2.

Also in the case where the input rate is f2, like in the case where the input rate is f1, the delay processing is performed by the delay elements 201 to 206, then the interpolation processing is performed by the interpolation process unit 22, and the data after the interpolation processing are inputted to the delay element 211 through the selector 237. In this case, however, the input delay control unit 21 outputs an enable signal of a f2 rate (hereinafter, referred to as a “f2 enable signal”).

The data after the interpolation processing which are outputted from the interpolation unit 22 are inputted to the delay element 211 through the selector 237. The delay elements 211 to 220 in this case perform the delay processing in accordance with an enable signal of a 2×f2 rate, which is outputted from the output delay control unit 230. Data as shown in FIG. 9 are outputted from the delay element 211.

As already discussed, the rate converter 20 has the need to keep the input-to-output times constant to prevent the situation where output timings of data vary with the rates of the inputted data and accordingly images are displaced. In this case, to make the input-to-output times equal in the case where the input rate is f2 and the case where the input rate is f1, there is the need to set the input-to-output time at 4×1/f1, i.e., 8×1/f2 when the input rate is f2. More specifically, when the input rate is f2, the data that have been subjected to the interpolation processing by the interpolation unit 22 are delayed by ten delay elements 211 to 220, to set the input-to-output time at 8×1/f2 (FIG. 9), and thereafter data outputted from the delay element 220 is selected by the selectors 235 and 236 as data to be outputted. The outputted data has a rate of 2×f2, and this means that the f2 rate of the input data is converted into a doubled rate. The conventional rate converter that handles data of the rates of f1 and f2 needs 16 delay elements on the whole.

A more description will be given of a case where the conventional rate converter outputs the inputted data through as it is, without subjecting the data to the interpolation processing.

When inputted data is outputted through as it is, the data that has not been processed yet by the interpolation unit 22 is outputted as it is in the same input-to-output time (4×1/f1 in this case) as in the case where the interpolation processing has been performed. Therefore, the selector 237 selects not an output from the interpolation unit 22 but an output from the delay element 206. Then, when the input rate of the inputted data is f1, it is required that the inputted data is delayed by four delay elements respectively by 1/f1, and accordingly the selector 234 selects an output of the delay element 204 and the selector 236 selects an output of the selector 234, thereby obtaining through-output data at the f1 rate. On the other hand, when the input rate is f2, it is required that the inputted data is delayed by eight delay elements respectively by 1/f2, and accordingly the selector 234 selects an output of the delay element 212 and the selector 236 selects an output of the selector 234, thereby obtaining through-output data at the rate f2. However, in contrast to the case where the input data is outputted after being subjected to the interpolation processing, when the inputted data is outputted through as it is without the interpolation processing, the output delay control unit 230 outputs the f1 enable signal in the case where the input rate is f1, which is the same signal as that outputted from the input delay control unit 210, while outputting the f2 enable signal in the case where the input rate is f2, which is the same signal as that outputted from the input delay control unit 210.

Here, when the conventional rate converter 20 outputs the inputted data as it is without performing the interpolation processing, the operation can be performed in the aforementioned manner with the above-mentioned construction of the rate converter as shown in FIG. 7, while this construction commonly utilizes the delay elements 211 and 212 in the delay processing for data after interpolation and in the delay processing for through-output data at the time of f2-rate through outputting, and thus when switching from the data after interpolation to the through-output data is instructed, the through-output data cannot be obtained immediately but data which are stored in the delay elements 211 and 212 at that time are outputted first, so that first two data after the switching are data that have been subjected to the interpolation processing. Therefore, the through-output data cannot be obtained without delay at a point of time when the switching from the output data after the interpolation to the through-output data is instructed. For the same reason, also when switching from the through-output data to the data after the interpolation is instructed, the output data after the interpolation cannot be obtained without delay.

To overcome this problem, the conventional rate converter 20 may be provided with delay elements 207 and 208 that are used for the through outputting at the f2 rate, as shown in FIG. 10. This construction allows desired data to be outputted without delay at a point of time when the switching between the through-output data and the output data after the interpolation is instructed.

However, holding the data after interpolation processing for adjusting the input-to-output time results in holding of data that have been subjected to the rate conversion by the interpolation processing to multiply the rate by an integral factor (twice in the case of the prior art). Consequently, more delay elements are required, and the scale of the rate converter is increased on the whole.

Further, as for the above-mentioned prior art, the description has been given of a case where there are two input rates (f1 and f2=2×f1), while more delay elements are required when there are three input rates (f1, f2=2×f1 and f3=2×f2). To be more specific, when assuming that the conventional rate converter handles data of three different input rates f1, f2 and f3, the input-to-output times corresponding to the respective input rates f1, f2 and f3 have the same value, and the interpolation unit 22 requires seven pieces of inputted data to perform the interpolation processing and converts the rate of the inputted data into a doubled rate, the input-to-output time in this case is 4×1/f1. When the input rate is f3, a f3 rate enable signal is outputted from the input delay control unit 210, and the rate of the data that is inputted at the f3 rate can be converted into a 2×f3 rate in a time of 4×1/f3, by means of the delay elements 201 to 206, 211, and 212 (eight delay elements) in FIG. 7. However, in order to keep the data input-to-output time constant (4×1/f1), the output delay unit 23 must subject the rate-converted data to delay processing at a rate of 2×f3, by an amount of time that is obtained by subtracting 4×1/f3 from 4×1/f1. The number of delay elements required for that process is:

(4×1/f1−4×1/f3)/(1/(2×f3)=24

Therefore, 32(=24+8) delay elements are required for the whole apparatus.

As can be seen from this example, when the number of input rates to be handled by the rate converter is increased, the number of delay elements for adjusting the output time is increased, resulting in an increased scale of the entire apparatus.

Further, to enable the conventional rate converter 20 as shown in FIG. 7 to obtain desired data without delay at a point of time when the switching between through-output data and output data after the interpolation processing is instructed, the number of necessary delay elements is increased further, as described with reference to FIG. 10. In addition, when high-rate data after the rate conversion is delayed to adjust the input-to-output time, the power consumption is adversely increased.

### SUMMARY OF THE TNVENTION

The present invention has for its object to provide a rate converter and a rate conversion method that can reduce the number of delay elements, thereby reducing the scale of the whole rate converter as well as reducing the power consumption.

Other objects and advantages of the invention will become apparent from the detailed description that follows. The detailed description and specific embodiments described are provided only for illustration since various additions and modifications within the spirit and scope of the invention will be apparent to those of skill in the art from the detailed description.

According to a 1st aspect of the present invention, there is provided a rate converter that performs rate conversion for plural kinds of input rates including: a delay unit that delays data that are inputted at the plural kinds of input rates so that input-to-output times from when the data are inputted to the rate converter to when the data are outputted therefrom are kept constant; and an interpolation unit that receives the data outputted from the delay unit, and integer-multiplies the rates of the data that are inputted to the delay unit to output data of the integer-multiplied rates.

According to a 2nd aspect of the present invention, there is provided a rate converter that performs rate conversion for plural kinds of input rates including: an input delay unit that delays inputted data successively by means of plural delay elements that are connected in series; a selection unit that selects data delayed by the respective delay elements in the input delay unit, from taps of the plural delay elements, according to each rate of the inputted data, so that input-to-output times from when the data at the plural kinds of rates are inputted to the rate converter to when the data are outputted therefrom are kept constant; an interpolation unit that performs interpolation processing for converting the rates of the data selected by the selection unit to be integer-multiplied; and an output delay unit that adjusts output timing of the data which have been subjected to the interpolation processing in the interpolation unit, by means of at least one delay element.

According to a 3rd aspect of the present invention, in the rate converter of the 2nd aspect, the output delay unit: receives data that are to be outputted through as they are (hereinafter, referred to as through-output data), from taps of the plural delay elements in the input delay unit according to respective rates of the inputted data, so that the input-to-output time of the inputted data in a case where the rate conversion is carried out and the input-to-output time of the inputted data in a case where through-outputting is carried out without performing the rate conversion are made equal; and outputs data that have been subjected to the output timing adjustment when the rate conversion is carried out, while outputting the through-output data that have been received from the input delay unit when the through-outputting is carried out.

According to a 4th aspect of the present invention, in the rate converter of the 2nd or 3rd aspect, the input delay unit delays the inputted data successively by means of the plural delay elements that are connected in series, using an enable signal corresponding to each of the input rates.

Therefore, the delay processing for adjusting the input-to-output time can be performed before the interpolation processing. Accordingly, the number of delay elements required for the entire rate converter can be reduced with relative to the conventional rate converter that performs the delay processing for adjusting the input-to-output time after the interpolation processing, thereby reducing the entire scale of the apparatus. In addition, the number of delay elements that operate at high rates is reduced, thereby reducing the power consumption.

Further, since the delay processing for adjusting the input-to-output time is performed before the interpolation processing, desired outputs can be obtained without delay after switching between the through-output data and the data after interpolation processing is instructed, without the need for extra delay elements. Accordingly, the number of delay elements can be reduced further with relative to the conventional converter that requires the extra delay elements.

According to a 5th aspect of the present invention, there is provided a rate conversion method for performing rate conversion to plural kinds of input rates including: a delay step of delaying data that are inputted at the plural kinds of rates so that times required to perform the rate conversion for converting the rates of the data to be integer-multiplied, respectively, are kept constant; and an interpolation step of outputting data of rates that are integer-multiplied rates of the inputted data, respectively.

According to a 6th aspect of the present invention, there is provided a rate conversion method for performing rate conversion to plural kinds of input rates including: an input delay step of delaying inputted data successively by means of plural delay elements that are connected in series; a selection step of selecting data delayed by the plural delay elements from taps of the plural delay elements according to each rate of the inputted data, so that times required to perform the rate conversion for converting the plural kinds of rates of the inputted data to be integer-multiplied, respectively, are kept constant; an interpolation step of performing interpolation processing for converting the rates of the data selected in the selection step to be integer-multiplied, respectively; and an output delay step of adjusting output timing of data after the interpolation processing, by means of at least one delay element.

Therefore, the delay processing for adjusting the input-to-output time can be performed before the interpolation processing. Accordingly, the number of delay elements required for the entire apparatus can be reduced with relative to the conventional rate converter that performs the delay processing for adjusting the input-to-output time after the interpolation processing, thereby reducing the entire scale of the apparatus. In addition, the number of delay elements that operate at high rates can be reduced, thereby reducing the power consumption.

### BRIEF DESCRIPTTON OF THE DRAWINGS

FIG. 1 is a block diagram illustrating a construction of a rate converter according to a first embodiment of the present invention.

FIG. 2 is a block diagram illustrating a detailed construction of the rate converter according to the first embodiment.

FIG. 3 is a flowchart showing an operation of the rate converter according to the first embodiment.

FIG. 4 are timing charts showing outputs from delay elements and the like in a case where an input rate is f1 according to the first embodiment.

FIG. 5 are timing charts showing outputs from the delay elements and the like in a case where an input rate is f2 according to the first embodiment.

FIG. 6 is a block diagram illustrating a construction of a conventional rate converter.

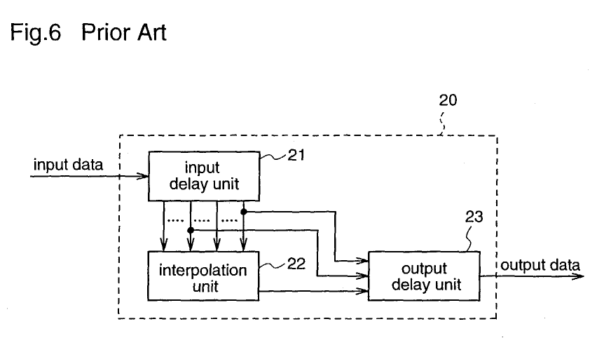

FIG. 7 is a block diagram illustrating a detailed construction of the conventional rate converter.

FIG. 8 are timing charts showing outputs from delay elements and the like in a case where an input rate is f1 according to the prior art.

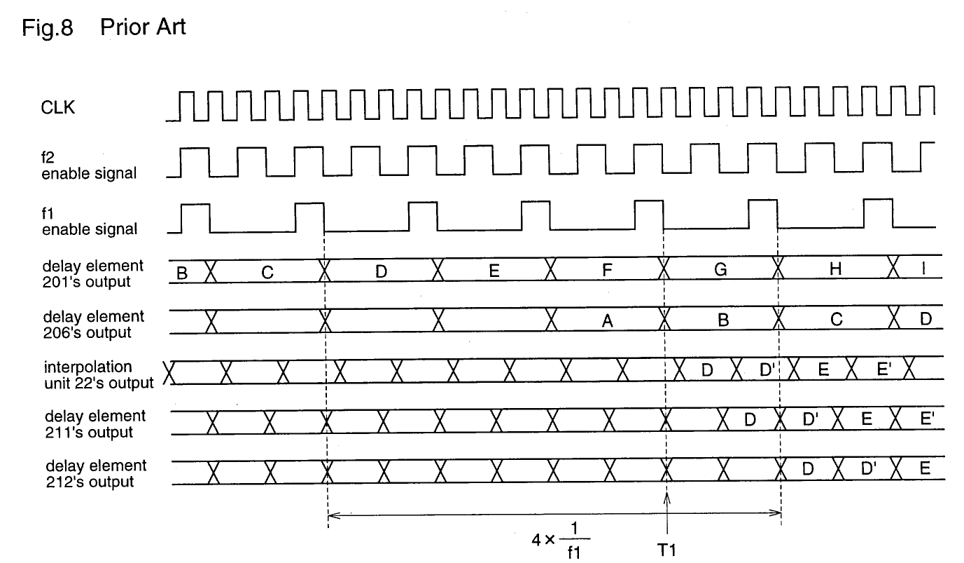

FIG. 9 are timing charts showing outputs from the delay elements and the like in a case where an input rate is f2 according to the prior art.

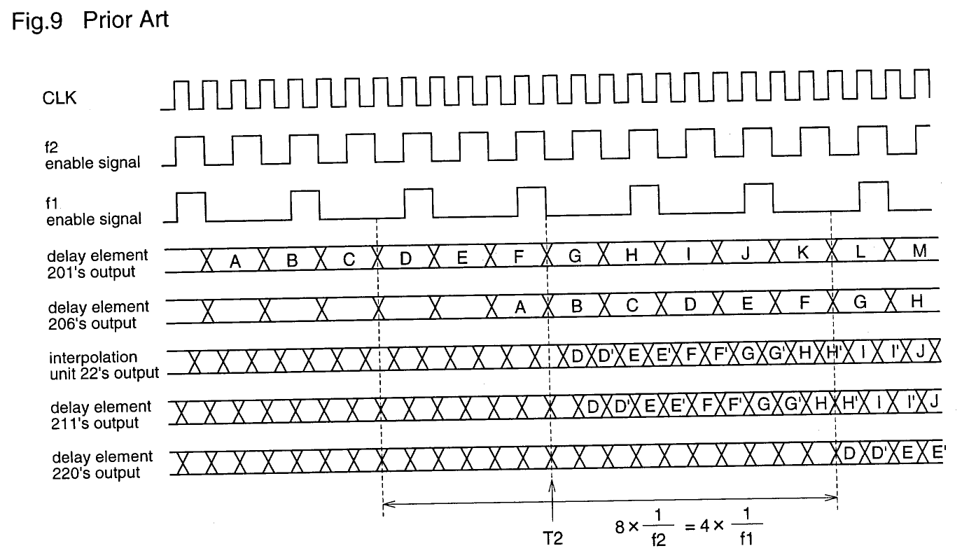

FIG. 10 is a block diagram illustrating a construction of a conventional rate converter.

### DETATLED DESCRIPTTON OF THE PREFERRED EMBODIMENTS

[Embodiment 1]

Hereinafter, a rate converter according to a first embodiment of the present invention will be described with reference to the drawings.

The rate converter according to the first embodiment performs delay processing for adjusting input-to-output time, before performing interpolation processing. In addition, the rate converter according to the first embodiment converts the rate of inputted data to be multiplied by an integral factor, whereby the input-to-output times corresponding to plural kinds of input rates are made equal. This rate converter is employed for rate conversion processing for video data, oversampling of audio, or the like.

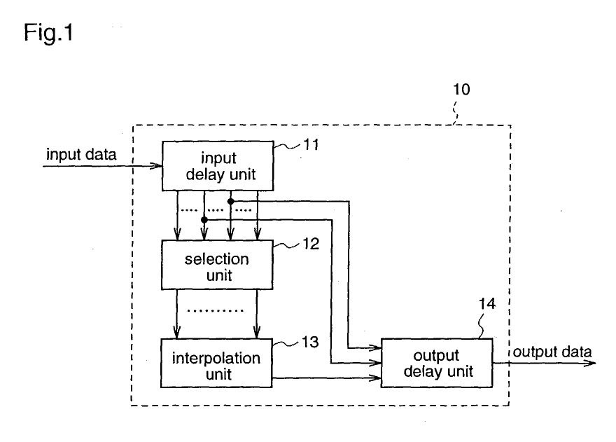

FIG. 1 is a block diagram illustrating a construction of the rate converter according to the first embodiment. In FIG. 1, a rate converter 10 of the first embodiment includes an input delay unit 11, a selection unit 12, an interpolation unit 13, and an output delay unit 14.

The input delay unit 11 delays inputted data successively by means of plural delay elements that are connected in series. The selection unit 12 selects data from taps of the plural delay elements according to the input rate, which data have been delayed by the respective delay elements of the input delay unit 11, so that the times from when the data of the respective rates are inputted into the rate converter 10 to when the data are outputted therefrom are kept constant.

The interpolation unit 13 performs interpolation processing to the data selected by the selection unit 12 so as to obtain a rate corresponding to an integral multiple of the input rate. The interpolation processing in this case is a process of inserting new data between data so as to multiply the rate of the data by an integral factor. To implement this process, there is for example a method by which inputted data are outputted as they are and new data are inserted between adjacent two pieces of the inputted data, or a method by which function approximation for some pieces of inputted data is performed, values obtained by the function approximation are outputted in place of the inputted data, and further the obtained values of the function approximation are inserted between adjacent two pieces of the inputted data as new data. A simple concrete example of the former is a method by which an average of adjacent two pieces of inputted data is outputted as new data to be inserted between the two pieces of data.

The output delay unit 14 adjusts the output timing of data after interpolation processing, by means of two delay elements. The output delay unit 14 further receives data from the input delay unit 11, which is the inputted data to be outputted through as it is without being subjected to the interpolation processing (hereinafter, referred to as through-output data), and outputs the received through-output data in place of the data after output timing adjustment, when the through-outputting is to be performed.

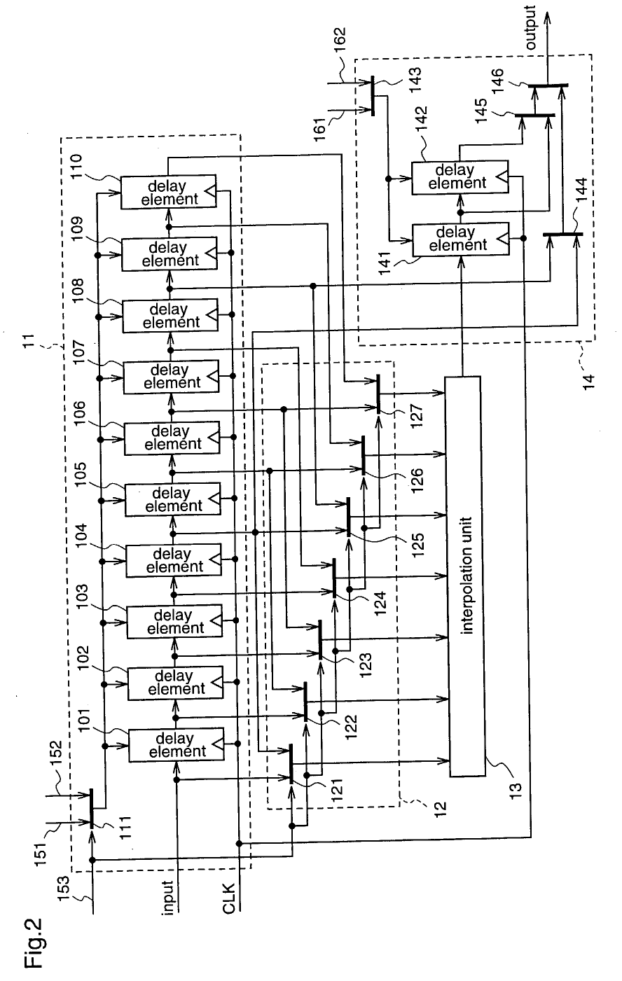

FIG. 2 is a block diagram illustrating a specific construction of the rate converter. The rate converter shown in FIG. 2 converts a f1-Hz rate of input data and a f2-Hz (f2=2×f1) rate of input data into doubled rates, respectively, and the interpolation unit 13 performs interpolation processing using seven pieces of data.

In FIG. 2, the input delay unit 11 includes ten delay elements 101 to 110 that are connected in series, and a selector 111. The delay elements 101 to 110 delay inputted data successively in accordance with an enable signal outputted from the selector 111. The selector 111 selects an enable signal 151 at the f1 rate (f1 enable signal) when a select signal 153 indicates the f1 rate, while selecting an enable signal 152 at the f2 rate (f2 enable signal) when the select signal 153 indicates the f2 rate.

The selection unit 12 includes selectors 121 to 127. The selectors 121 to 127 select data from taps on the input side of the delay elements 101 to 107 when the select signal 153 indicates the f1 rate, while selecting data from taps on the output side of the delay elements 104 to 110 when the select signal 153 indicates the f2 rate, respectively. The data selected by the selectors 121 to 127 are inputted to the interpolation unit 13.

The output delay unit 14 includes two delay elements 141 and 142, and selectors 143 to 146. The delay elements 141 and 142 adjust the output timing of the data after interpolation processing by the interpolation unit 13, in accordance with an enable signal outputted from the selector 143. The selectors 143 to 146 are controlled by a select signal (not shown), and select signals or data indicated by the select signal. The selector 143 selects an enable signal 161 at a 2×f1 rate when the rate of the data inputted to the rate converter 10 is f1, while selecting an enable signal 162 at a 2×f2 rate when the rate of the inputted data is f2. The selector 144 receives the through-output data of the case where the input rate is f1 and the through-output data of the case where the input rate is f2 from the delay elements 104 and 108, respectively, and selects one of the data according to the input rate. The selector 145 selects the output data from the delay element 142 when two delay elements are employed to adjust the output timing, while selecting the output data from the delay element 141 when only one delay element is employed to adjust the output timing. The selector 146 selects data from the selector 145 when the rate conversion is to be performed, while selecting data from the selector 144 when the data is outputted through as it is without being subjected to the rate conversion.

Next, the operation of the rate converter 10 according to the first embodiment will be described.

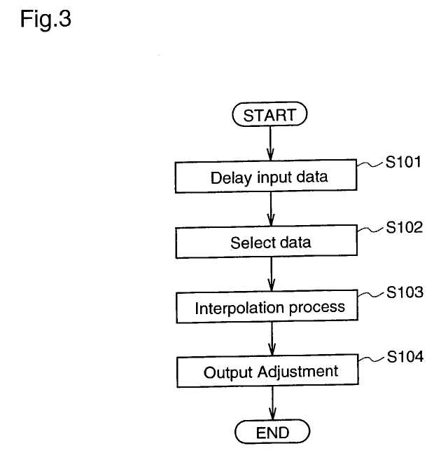

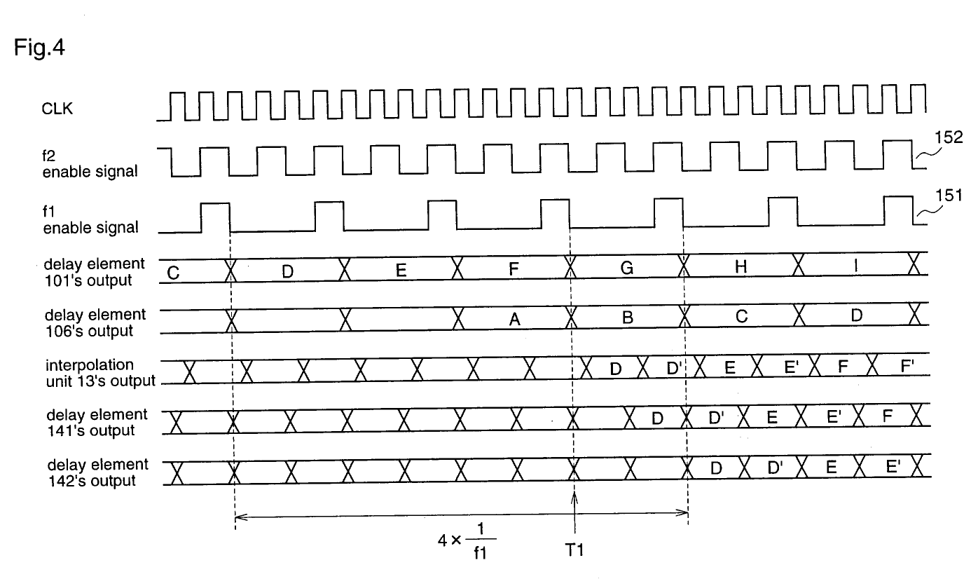

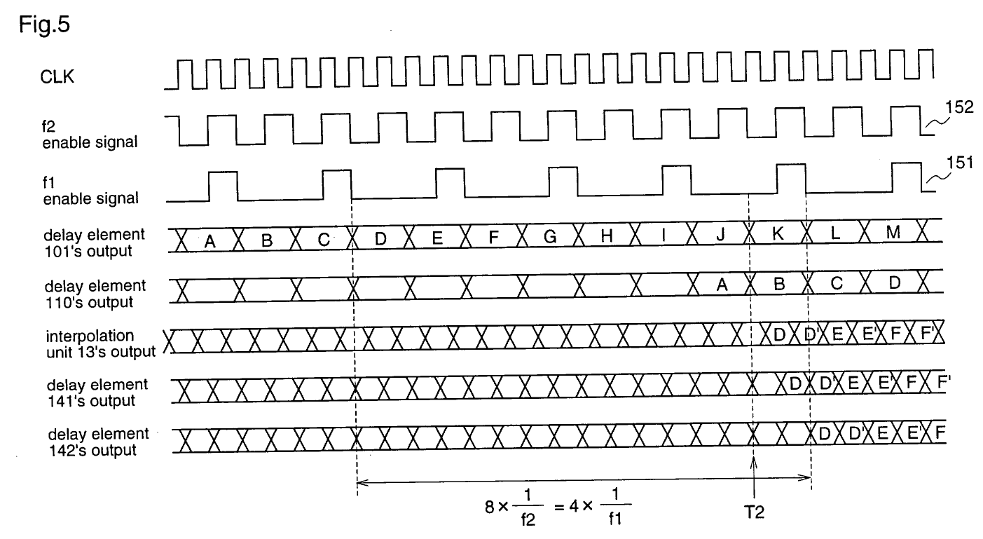

FIG. 3 is a flowchart showing the operation of the rate converter according to the first embodiment. FIGS. 4 and 5 are timing charts for signals which are outputted from respective units of the rate converter in cases where the input rates are f1 and f2, respectively.

Initially, the case where fl-rate data is inputted to the rate converter 10 according to the first embodiment is described with reference to FIG. 4.

Initially in step S101, the selector 111 selects the f1 enable signal 151 in accordance with the selector signal 153 indicating the f1 rate, whereby the data inputted to the input delay unit 11 is transmitted through the delay elements 101 to 110 in accordance with the f1 enable signal 151 and successively delayed.

Then, in step S102, the data that have been successively delayed by the respective delay elements 101 to 110 are inputted to the corresponding selectors 121 to 127 of the selection unit 12. The selectors 121 to 127 select seven pieces of data which are required for the interpolation processing, from taps on the input side of the delay elements 101 to 107, respectively, in accordance with the instruction of the select signal 153, and output the selected data to the interpolation unit 13.

Then, in step S103, the interpolation unit 13 receives the seven pieces of data from the selection unit 12, and performs the interpolation processing. More specifically, when the seven pieces of data are inputted, the interpolation unit 13 outputs data in the middle of the data (fourth data from the first) as it is, and then interpolates data between the fourth and fifth data. Therefore, as shown in FIG. 4, when data of “A”, “B”, “C”, “D” , . . . are inputted, the interpolation unit 13 receives seven data of “A”, “B” , . . . , “F”, “G” at timing of T1, first outputs “D” that is data in the middle of the seven data, and then outputs “D′” that is data to be inserted between “D” and “E”. As the interpolation unit 13 doubles the rate of the inputted data, the output data from the interpolation unit 13 has a rate of f2=2×f1.

Thereafter, in step S104, the output delay unit 14 adjusts output timing of the data after interpolation, which is outputted from the interpolation unit 13. That is, as shown in FIG. 4, the delay element 141 delays the data from the interpolation unit 131 in accordance with the enable signal 161 of a 2×f1 rate outputted from the selector 143. Data outputted from the delay element 141 is further delayed by the delay element 142, and the delayed data is outputted to outside the rate converter 10 through the selectors 145 and 146. Here, when an apparatus that receives the outputs from the rate converter 10 does not require the output timing adjustment by the delay element 142, the output data from the delay element 141 may be outputted outside the rate converter 10 through the selectors 145 and 146. This may apply to the case where the rate of the inputted data is f2.

In this case, as is apparent from FIG. 4, the input-to-output time is 4×1/f1.

Next, the case where f2-rate data is inputted to the rate converter 10 according to the first embodiment is described with reference to FIG. 5.

Initially, the selector 111 selects the f2 enable signal 152 in accordance with the selector signal 153 indicating the f2 rate, whereby the data inputted to the input delay unit 11 is transmitted through the delay elements 101 to 110 in accordance with the f2 enable signal 152 and successively delayed, like in the above-mentioned case of the f1 rate (step S101).

Then, in step S102, the data that have been successively delayed by the delay elements 101 to 110 are inputted to the corresponding selectors 121 to 127 of the selection unit 12, and the selectors 121 to 127 select seven pieces of data which are required for the interpolation processing, from taps on the output side of the delay elements 104 to 110, respectively, in accordance with the instruction of the select signal 153, and output the selected data to the interpolation unit 13. Here, the reason why different data are selected in the case of the f2 rate and the case of the f1 rate is because, in the case of the f2 rate, the data is be delayed more than in the case of the f1 rate, to make the input-to-output times in the cases of the f1 rate and the f2 rate equal.

As described above, the interpolation unit 13 receives the seven pieces of data selected by the selection unit 12 and performs the interpolation processing (step S103), and further the output delay unit 14 adjusts the output timing of the data after interpolation (step S104). This operation is the same as in the case of the f1 rate, and thus the description is not given here. However, since the interpolation unit 13 carries out a process for doubling the rate, the data after the interpolation has a rate of 2×f2, and the enable signal from the selector 143, which is employed in the output delay unit 14, is an enable signal 162 at a 2×f2 rate. In FIG. 5, the timing when the interpolation unit 13 receives the seven pieces of data (“A”, “B” , . . . , “G”) to perform the interpolation processing is denoted by T2.

Here, in the case where the rate of the inputted data is f2, when only the rate conversion is performed, the input-to-output time is 4×1/f2. However, to obtain the same input-to-output time as that in the case where the rate is f1, the data is delayed further by 4×1/f2 with using the delay elements 101 to 104. Consequently, the input-to-output time in the case where the rate is f2 is 8×1/f2=4×1/f1, which is the same rate as in the case where the rate is f1 (see FIG. 5).

Next, the case where data is outputted through as it is without being subjected to the rate conversion (interpolation processing) will be described.

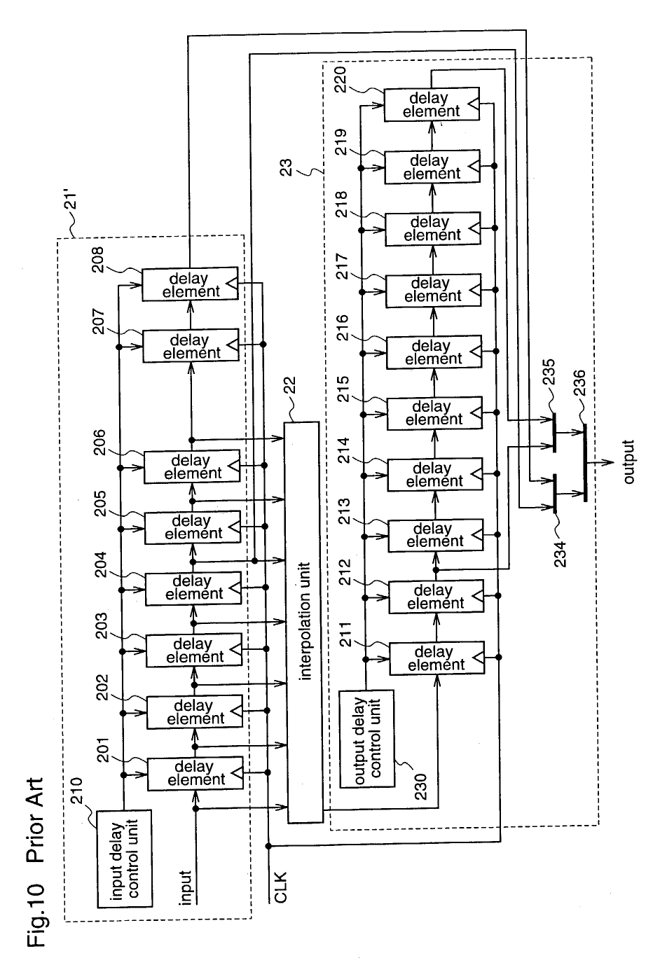

In the prior art, when switching between the through-output data and the data after the interpolation is to be performed, extra delay elements should be provided to output desired data without delay (see FIG. 10). However, in the rate converter according to the first embodiment, more delay elements than in the prior art are provided in the input delay unit 11, i.e., on the data input side of the interpolation unit 13, to perform the delay processing for adjusting the input-to-output time before the interpolation processing. Thus, this rate converter can obtain the desired output without delay at a point of time when the switching between the through-output data and the data after interpolation is instructed, without the need for extra delay elements as in the prior art.

To be more specific, data outputted from taps on the output side of the delay elements 104 and 108 are inputted to the output delay unit 14, and the selector 144 selects the data from the tap on the output side of the delay element 104 in the case where the rate is f1 while the selector 144 selects the data from the tap on the output side of the delay element 108 in the case where the rate is f2, whereby through-output data in the cases where the rates are f1 and f2 can be outputted, respectively. In this case, the selector 146 selects output data from the selector 144.

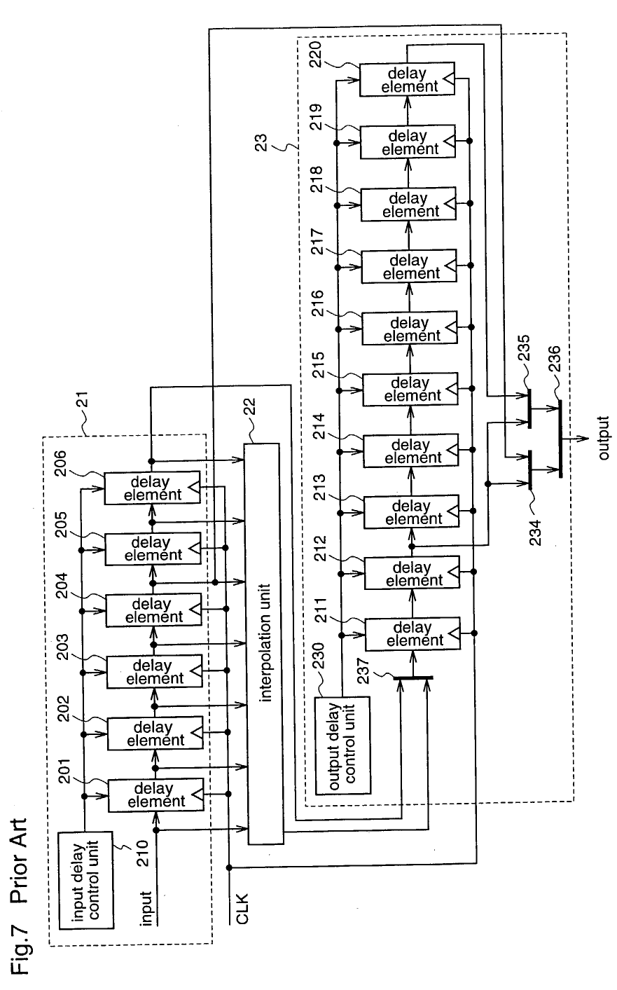

As described above, the rate converter according to the first embodiment includes the input delay unit 11 that successively delays inputted data by means of the delay elements 101 to 110; the selection unit 12 that selects data from taps of the delay elements in the input delay unit 11 according to the input rate, so that the input-to-output times corresponding to inputted data of the respective rates are made equal; the interpolation unit 13 that subjects the data selected by the selection unit 12 to the interpolation processing for doubling the rate; and the output delay unit 14 that adjusts output timing of the data after interpolation by means of the delay elements 141 and 142. Therefore, the delay processing for keeping the input-to-output times corresponding to the respective rates constant can be performed before the interpolation processing. Consequently, as compared to the prior art in which the delay processing for adjusting the input-to-output times is performed after the interpolation processing, the number of delay elements required for the entire rate converter can be reduced. More specifically, the number of delay elements required in the prior art as shown in FIG. 7 is 16, while the number of the delay elements required for the rate converter 10 according to the first embodiment is 12.

Further, the rate converter 10 of the first embodiment can obtain desired outputs without delay after switching between through-output data and the output data after interpolation is instructed, without the need for extra delay elements. Thereby, as compared to the conventional rate converter 20 that requires extra delay elements for through-output data (see FIG. 10), the number of delay elements can be further reduced.

In this first embodiment, the description has been given of the exemplary interpolation processing by the interpolation unit 13 in which the interpolation unit 13 receives seven pieces of data, first outputs the fourth data, and then interpolates data between the fourth and fifth data. However, the interpolation processing may be carried out in any manner. For example, it is possible that the interpolation unit 13 receives seven pieces of data, first outputs the third data, and then interpolates data between the third and fourth data.

Further, in this first embodiment, the description has been given of the case where, among plural kinds of input rates of data that are inputted to the rate converter 10, one input rate is twice as high as the other rate. However, the rate may be an integral multiple of the other rate, or the like.

In this first embodiment, for the sake of simplification, the description has been given of the case where there are two kinds of input rates (f1 and f2=2×f1). However, in a case where data are inputted to the rate converter of the first embodiment at three kinds of input rates (f1, f2=2×f2, and f3=3×f3), the difference of this rate converter and the conventional converter becomes more remarkable. More specifically, also in the case where there are three kinds of input rates (f1, f2 and f3), the input-to-output time is 4×1/f1, and when the input rate is f3, this rate converter can convert the rate of data that is inputted at the rate of f3 into a rate of 2×f3 in a time of 4×1/f3, with using six delay elements in the input delay unit 11 and two delay elements in the output delay unit 14. However, to keep the input-to-output time of the data constant (at 4×1/f1), the delay processing must be performed in the input delay unit 11 to the data after interpolation at the f3 rate, for an amount of time that is obtained by subtracting 4×1/f3 from 4×1/f1. The number of delay elements that are required for that process is:

(4×1/f1−4×1/f3)/(1/f3)=12.

Therefore, the rate converter of the first embodiment requires 20 delay elements (=8+12) on the whole. As the conventional converter requires 32 delay elements as already described, the rate converter 10 of the first embodiment only requires about two-thirds the number of delay elements in the prior art.

As mentioned above, according to the rate converter of the present invention, the number of delay elements can be reduced as compared to the prior art, regardless of the number of kinds of input rates or the rate conversion ratio.

What is claimed is:

1. A rate converter that performs rate conversion for plural kinds of input rates, including:
a delay unit that delays data that are inputted at the plural kinds of input rates so that input-to-output times from when the data are inputted to the rate converter to when the data are outputted therefrom are kept constant; and
an interpolation unit that receives the data outputted from the delay unit, and integer-multiplies the rates of the data that are inputted to the delay unit to output data of the integer-multiplied rates.

2. A rate converter that performs rate conversion for plural kinds of input rates, including:
an input delay unit that delays inputted data successively by means of plural delay elements that are connected in series;
a selection unit that selects data delayed by the respective delay elements in the input delay unit, from taps of the plural delay elements, according to each rate of the inputted data, so that input-to-output times from when the data at the plural kinds of rates are inputted to the rate converter to when the data are outputted therefrom are kept constant;
an interpolation unit that performs interpolation processing for converting the rates of the data selected by the selection unit to be integer-multiplied; and
an output delay unit that adjusts output timing of the data which have been subjected to the interpolation processing in the interpolation unit, by means of at least one delay element.

3. The rate converter of claim 2 wherein
the output delay unit: receives data that are to be outputted through as they are (hereinafter, referred to as through-output data), from taps of the plural delay elements in the input delay unit according to respective rates of the inputted data, so that the input-to-output time of the inputted data in a case where the rate conversion is carried out and the input-to-output time of the inputted data in a case where through-outputting is carried out without performing the rate conversion are made equal; and
outputs data that have been subjected to the output timing adjustment when the rate conversion is carried out, while outputting the through-output data that have been received from the input delay unit when the through-outputting is carried out.

4. The rate converter of claim 2 or 3 wherein
the input delay unit delays the inputted data successively by means of the plural delay elements that are connected in series, using an enable signal corresponding to each of the input rates.

5. A rate conversion method for performing rate conversion to plural kinds of input rates, including:
a delay step of delaying data that are inputted at the plural kinds of rates so that times required to perform the rate conversion for converting the rates of the data to be integer-multiplied, respectively, are kept constant; and
an interpolation step of outputting data of rates that are integer-multiplied rates of the inputted data, respectively.

6. A rate conversion method for performing rate conversion to plural kinds of input rates including:
an input delay step of delaying inputted data successively by means of plural delay elements that are connected in series;
a selection step of selecting data delayed by the plural delay elements from taps of the plural delay elements according to each rate of the inputted data, so that times required to perform the rate conversion for converting the plural kinds of rates of the inputted data to be integer-multiplied, respectively, are kept constant;
an interpolation step of performing interpolation processing for converting the rates of the data selected in the selection step to be integer-multiplied, respectively; and
an output delay step of adjusting output timing of data after the interpolation processing, by means of at least one delay element.
